(19) United States
(12) Patent Application Publication
(10) Pub. No.: US 2003/0163210 A1
(43) Pub. Date: Aug. 28, 2003

(54) System for providing golfers with golf related information via a global network

(76) Inventor: Edwin H. Adams, Grover Beach, CA (US)

Correspondence Address: Howard N. Flaxman, Suite 112, 2341 Jefferson Davis Hwy., Arlington, VA, 22202, US

(21) Appl. No.: 10/080,571

(22) Filed: Feb. 25, 2002

(51) Int. Cl. G06F 155/00

(52) U.S. Cl. 700/91

(57) ABSTRACT

A system for providing golfers with golf related information includes a personal digital assistant having a GPS function, a memory, a processor and an input/output. The system also includes a cradle shaped and dimensioned for receiving the personal digital assistant and transferring information thereto. The cradle includes a memory storing information relating to coordinates on a golf course and an input/output transmitting information to the personal digital assistant. The personal digital assistant includes software for calculating and displaying distance between a golfer's location and a designated coordinate on the golf course.

### CROSS REFERENCE TO RELATED APPLICATIONS

This application relates to commonly owned U.S. patent application Ser. No. 09/631,629, entitled “System for Providing Golfers with Golf Related Information Via a Global Network”, filed Aug. 4, 2000, which is currently pending, and, to the extent relevant, incorporated herein by reference.

### BACKGROUND OF THE INVENTION

1. Field of the Invention

The invention relates to a golfer's aid. More particularly, the invention relates to a method and system allowing golfers to download particular golf course information to a personal digital assistant containing a global positioning satellite chip.

2. Description of the Prior Art

More people around the world than now play golf at any time since the game was invented. A wide variety of mechanical advances have been recently applied to improve an individual's ability to play and enjoy a round of golf. These advances include new training equipment, clubs fabricated from advanced materials, reshaped club heads, aerodynamically designed golf balls improving upon a golfer's ability to hit a ball toward a desired target, and a host of other advances focused upon improving the game of both novices and experts.

However, those associated with the game of golf have yet to fully take advantage of information technology, including, but not limited to, convenient information transfer via portable digital assistants, the power offered by the Internet and other global communication networks, and global positioning satellites (GPS), to improve upon golfers' ability to play and enjoy a round of golf. With this in mind, the present invention offers a readily usable information transfer device designed to improve upon one's enjoyment of a round of golf.

### SUMMARY OF THE INVENTION

It is an object of the present invention to provide a system for providing golfers with golf related information. The system includes a personal digital assistant having a GPS function, a memory, a processor and an input/output. The system also includes a cradle shaped and dimensioned for receiving the personal digital assistant and transferring information thereto. The cradle includes a memory storing information relating to coordinates on a golf course and an input/output transmitting information to the personal digital assistant. The personal digital assistant includes software for calculating and displaying distance between a golfer's location and a designated coordinate on the golf course.

It is also an object of the present invention to provide a similar method for providing golf related distance information.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system.

FIG. 2 is a schematic of the central processor in accordance with the present invention.

FIG. 3 is a view of a personal digital assistant used in accordance with the present invention.

FIG. 4 is flow chart for the uploading of golf course information to the golf course module.

FIGS. 5 and 6 show various displays in accordance with the present invention.

FIG. 7 is schematic of personal digital assistant in accordance with an alternate embodiment of the present invention.

FIG. 8 is a schematic of a representative golf hole.

FIG. 9 is a schematic of a cradle and a PDA used in accordance with an alternate embodiment of the present invention.

### DESCRIPTION OF THE PREFERRED EMBODIMENTS

The detailed embodiments of the present invention are disclosed herein. It should be understood, however, that the disclosed embodiments are merely exemplary of the invention, which maybe embodied in various forms. Therefore, the details disclosed herein are not to be interpreted as limited, but merely as the basis for the claims and as a basis for teaching one skilled in the art how to make and/or use the invention.

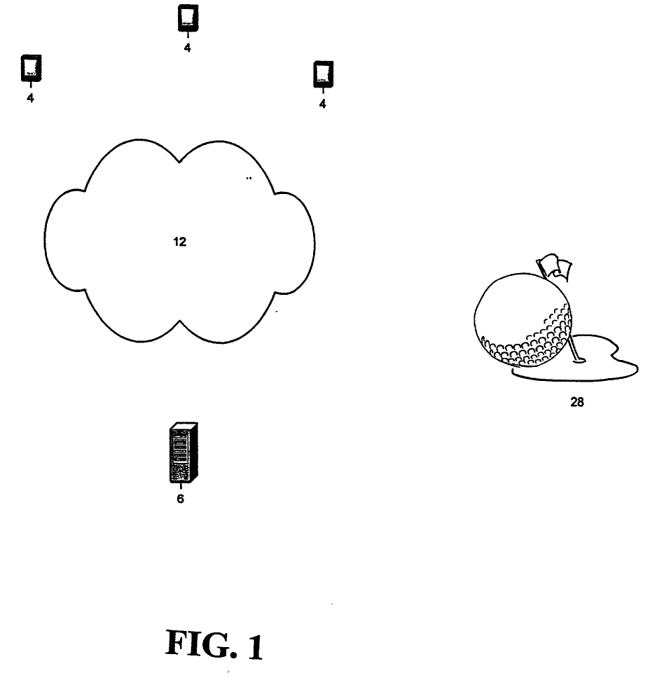

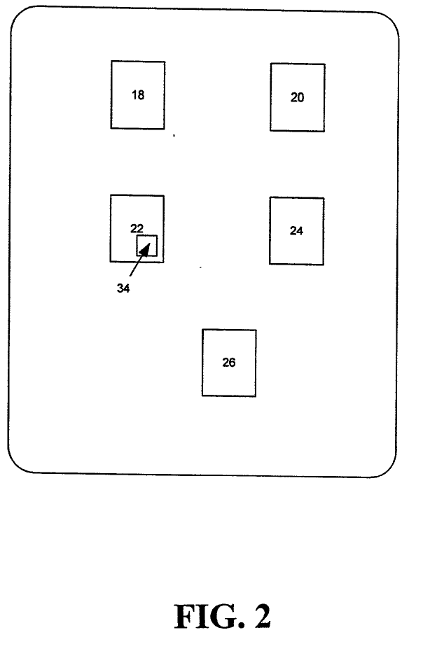

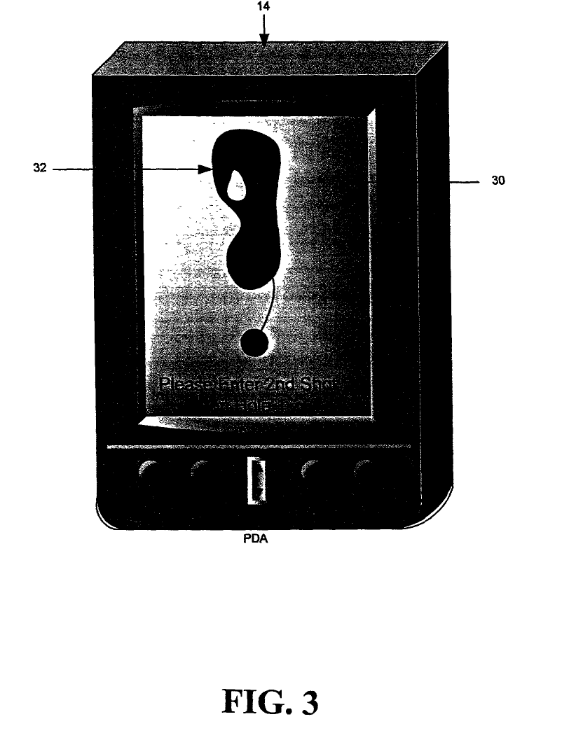

With reference to FIGS. 1, 2 and 3, a system 10 for providing golfers with golf related information via a global communication network 12, for example, the Internet, is disclosed. In accordance with a preferred embodiment of the present invention, the system 10 utilizes the Internet 12 to facilitate the transfer of information between a user station 14 and a central processor 16 of the present system 10. The transfer of information between the user station 14 and the central processor 16 is facilitated through the use of TCP/IP, although other communication protocols may be utilized without departing from the spirit of the present invention.

As will be discussed below in greater detail, the user station 14 may take a variety of forms depending upon the needs of the individual accessing the central processor 16 of the present system 10. In accordance with a preferred embodiment of the present invention, the user stations are personal digital assistants 14. This allows golfers to readily download relevant information as discussed below and bring the information onto the course with them. However, it is contemplated that the central processor 16 may also be accessed via desktop computers, laptop computers, and cellular communication devices, although those skilled in the art will readily understand that many other communication devices may be utilized without departing from the spirit of the present invention.

The cornerstone of the present system is a central processor 16 accessed by the user via the Internet 12. The central processor 16 includes a golf course module 18, a score entry module 20, a statistic storage module 22, an analysis module 24 and a playing tip module 26.

The golf course module 18 contains golf course information from a plurality of golf courses. The information maintained in the golf course module 18 includes, for example, hole layouts, distances, pin and tee placements, hazard locations, and topographical data. The previous list of golf course information which maybe stored in the golf course module 18 is considered to be merely exemplary of information which might be useful to golfers accessing the central processor 16 in accordance with the present invention, and the list of available golf course information may be readily varied to suit the needs of golfers as available information changes and the needs of those golfers accessing the central processor 16 changes.

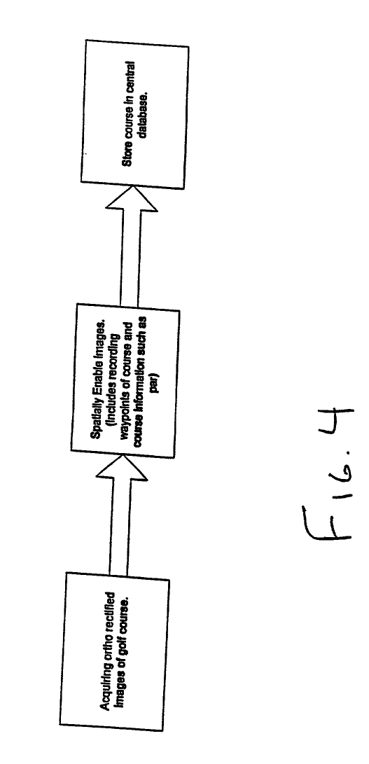

The golf course module 18 is readily accessed by those using the central processor 16. As such, golf course information stored therein may be readily downloaded. Similarly, golf course information maybe readily uploaded to the golf course module 18. The proprietors of golf courses 28 participating with the present system 10 are thereby permitted to continually keep their course information up-to-date so that golfers at these courses will have the most up to date information available as they access the central processor 16. The process for uploading information is generally outlined in FIG. 4. Briefly, the golf course module first acquires ortho-rectified images of a golf course. The images are then spatially enabled, including, recording waypoints of the course and course information, such as, par. Finally, the golf course module stores the information.

The score entry module 20 is designed to allow a golfer to input each shot from a round of golf in relation to the golf course information maintained in the golf course module 18. With this in mind, the score entry module 20 provides the golfer with a graphical user interface when golfers download golf course information from the central processor 16. As such, the interface 30 maybe used by a golfer to enter each shot by marking ball positions on a rendering of a hole layout 32.

For example, the interface 30 provides the golfer with the layout of hole 1 at the golfer's local golf course. The golfer is then prompted to enter the location of his or her first shot, second shot etc. The shot information is stored and placed within the statistic storage module 22.

The statistic storage module 22 includes a database 34 in which data input via the score entry module 20 is maintained for subsequent processing to provide golfers with desired information. The analysis module 24 and playing tip module 26 are linked to the statistic module 22. Specifically, the analysis module 24 is associated with the statistic storage module 22 and the golf course module 18 for adding-value to the information contained therein. Value-added information is considered to be information developed from multiple sources such that the resulting information provides a benefit not provided by information generated from a single source.

For example, the analysis module 24 might determine that a golfer hits his tee shot in the rough on the second hole 80 percent of the time by comparing the stored shot information and the course information. This information would then be passed onto the golfer.

Similarly, the playing tip module 26 offers golfers information concerning their golf game based upon information maintained by the statistic storage module 22. With this in mind, the playing tip module 26 is linked with the analysis module 24 and statistic storage module 22 to provide customized tips based upon value-added information generated by the analysis module 24.

As mentioned above, a golfer may access the central processor 16 of the present system 10 through the use of a personal digital assistant 14. Enhanced use of the personal digital assistant 14 is provided by the inclusion of a global positioning chip 36, or system, within the personal digital assistant 14.

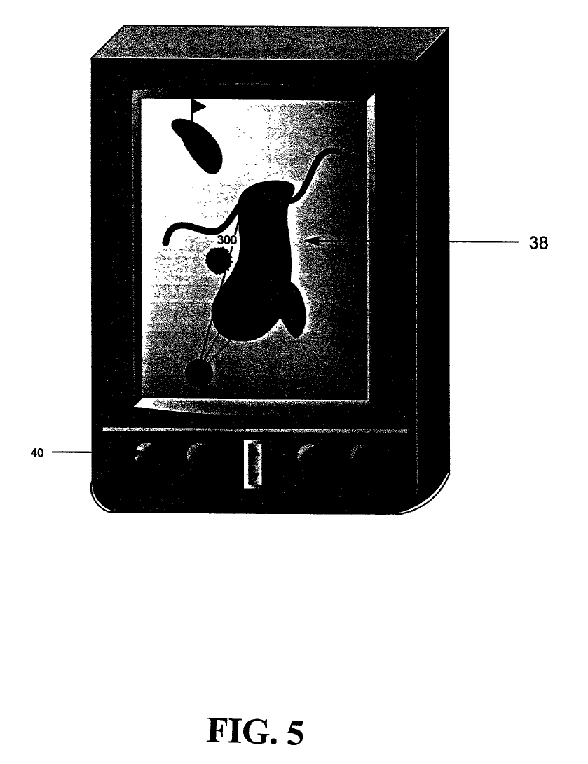

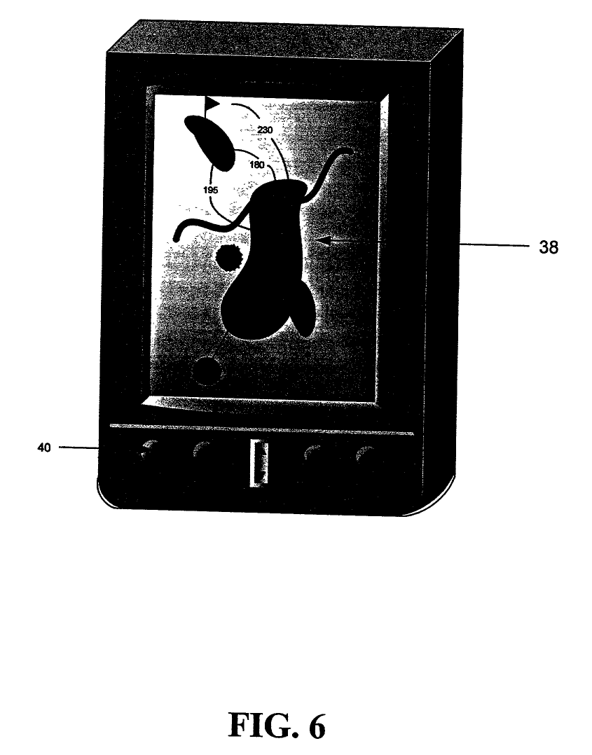

When a global positioning chip 36 is used in conjunction with a downloaded golf course, a software program within the personal digital assistant permits the global positioning chip 36 to take a reading of the golfer's location, calculate the golfer's position on the golf course and display all desired distances on any given hole (see FIGS. 5 and 6). For example, it is contemplated that a golfer may simply point upon the personal digital assistant 14 to identify the distance between two points on the golf course. The personal digital assistant 14 is carried by the golfer as he or she plays a round of golf and is able to continually determine the golfer's position on the course. This position information is used by the personal digital assistant 14 to provide the golfer with a wealth of real-time information.

In accordance with one embodiment of the present system, the golf course module contains ortho-rectified pictures of the golf holes of a plurality of golf courses. The ortho-rectified pictures are downloadable to the personal digital assistant 14 using conventional downloading techniques currently available. Specifically, and with reference to FIGS. 4 and 5, the system 10 utilizes a global communication network 12 to transfer ortho-rectified pictures 38 of golf holes of golf courses to the personal digital assistant 14 containing a global positioning satellite chip 36. The transfer of the ortho-rectified pictures 38 to the personal digital assistant 14 is facilitated through the use of TCP/IP, although other communication protocols may be utilized without departing from the spirit of the present invention. It is also contemplated that the golf course information may be accessed via a desktop PC or cellular communication device, although those skilled in the art will readily understand the many other communication devices that may be utilized without departing from the spirit of the present invention. The cornerstone of this feature of the system 10 is to allow the golfer to bring the ortho-rectified pictures 38 of golf holes of a golf course to the golf course on a personal digital assistant 14 containing a global position satellite chip 36 for the purpose of retrieving and storing golf related information.

When the global positioning satellite chip 36 of the personal digital assistant 14 is used in conjunction with the downloaded ortho-rectified pictures 38 of golf holes of a golf course, a software program within the personal digital assistant 14 permits the global positioning satellite chip 36 to take a reading of the golfer's location and to calculate and display the golfer's position on the personal digital assistant. Then, using the software and the ortho-rectified pictures 38, the personal digital assistant 14 is able to calculate and display relevant distances to desired geographical and topographical locations on the golf hole. This may be done time and again throughout a round of golf.

For example, a golfer is going to play course A tomorrow. The golfer can access course A from the courses stored on the golf course module 18 and download the ortho-rectified pictures 38 and software of course A to a personal digital assistant 14 which the golfer takes to the course. When the golfer commences the round, the golfer is on the back tee box of hole 1, a long par four. The golfer presses the global positioning satellite button 40 on the personal digital assistant 14 which then displays to the golfer that the location is the back tee, the distance to clear the lake is 160 yards, the distance to a preferred spot in the middle of the fairway is 260 yards and the length necessary to clear the large tree necessary to cut the corner of the slight dog leg is 300 yards in the air (see FIG. 5). After hitting the drive in the preferred spot in the middle of the fairway, the golfer then stands next to the ball and again presses the global positioning satellite chip button 40 to take a reading. The golfer learns that the drive was 265 yards, that the remaining distance to the front of the green is 180 yards, the remaining distance to the middle of the green is 195 yards, the distance to the out of bounds marker behind the green is 230 yards and the distance to clear the creek running in front of the green is 165 yards (see FIG. 6).

In summary, by integrating the global positioning satellite chip 36 contained in the personal digital assistant 14 with the ortho-rectified pictures 38 of the golf holes downloaded to the personal digital assistant 14 position information is made readily available to the golfer. Specifically, once a global positioning system reading of the golfer's location on a given golf hole is taken, the personal digital assistant 14 uses that reading in conjunction with the ortho-rectified pictures 38 to calculate and display distances to desired locations on the golf hole.

In addition to providing position information, the golfer may input each of his or her shots for later uploading to the score entry module 20 of the central processor 16. Specifically, the golfer will input the exact location of each shot, thereby creating a map of the shot taken as the golfer makes his or her way through a round of golf. This creates not only a record of the golfer's score, but a record of the position of each shot taken by the golfer during his or her round.

The information retrieved by the golfer while on the golf course is stored in the personal digital assistant 14 and is by uploaded by the golfer to the golfer's personal account on the central processor 16 accessed via the global communication network 12. Uploading of the information is performed using conventional technology currently available.

In accordance with alternate embodiments of the present invention, the personal digital assistant may be continually linked with the central processor during a round of golf, thereby, eliminating the need to upload information at the end of a round of golf. Specifically, the personal digital assistant would be linked to the score entry module of the central processor and each stroke is thereby directly uploaded to the central processor immediately after it is recorded on the personal digital assistant by the golfer. That is, the golfer will simply input a shot immediately after completion, at which time the personal digital assistant will transmit the shot and position information to the score entry module for recordation.

In practice, the present system provides golfers with golf related information by providing a central processor via a global communication network The central processor includes a golf course module containing golf course information from a plurality of golf courses, a score entry module including means allowing a golfer to input each shot from a round of golf in relation to the golf course information maintained in the golf course module and a statistic storage module including a database in which data input via the score entry module is maintained for subsequent processing to provide golfers with desired information. The system then gathers scoring information from individuals accessing the central processor and processes the scoring information to add value thereto.

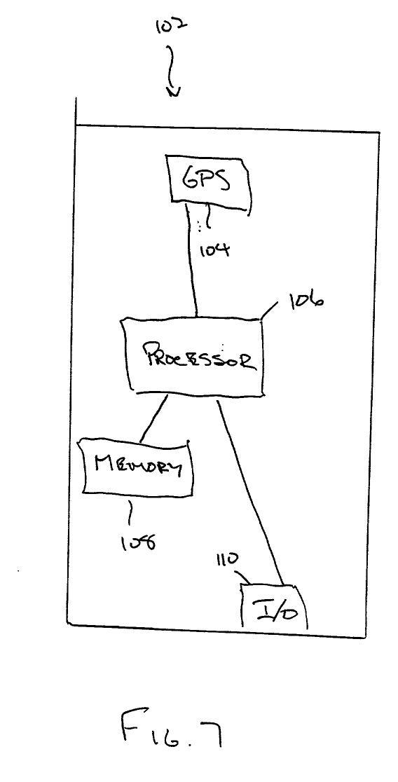

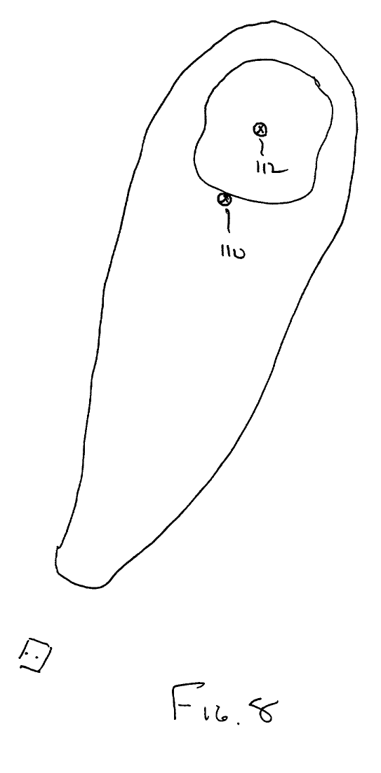

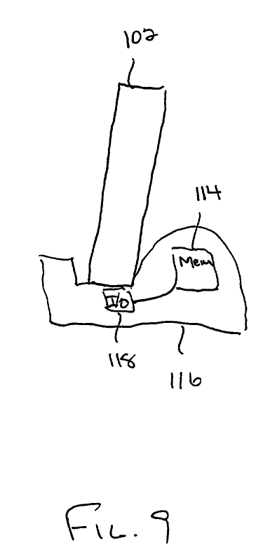

A simplified version of the present system is also contemplated in accordance with the present invention. With reference to FIGS. 7 to 9, and in accordance with this embodiment, a personal digital assistant 102 including a GPS function 104 is provided. In addition to the GPS function 104, the PDA 102 need only be provided with a memory 106, processor 108 and input/output 110.

In practice, an operator of the present system will obtain two location readings for each hole of each golf course participating in the present system; a first location reading 111 relating to the front of the green and a second location reading 112 relating to the middle of the green. As such, only 36 readings are required for each course participating in the present system.

It is contemplated that an operator will simply walk the course while carrying a PDA loaded with software designed to record location readings. The location readings are recorded and stored within the PDA, and subsequently uploaded to a central processor. The central processor then crunches the location readings into first and second coordinates to be used by golfers in a manner described below in greater detail.

In order to obviate the need for Internet connections as discussed above in accordance with the prior embodiment, the present embodiment utilizes the generated first and second coordinates 111, 112 respectively relating to the front of the green and the middle of the green by storing the coordinates within the memory 114 of a PDA cradle 116 maintained at the respective golf course facility. With this in mind, a golfer need only show up to play golf carrying his PDA 102 loaded with software for operating in accordance with the present invention.

Specifically, the golfer will place his or her PDA 102 upon the cradle 116, pay a required charge and upload the coordinates for the course he or she is about to play. The required coordinates are uploaded via the input/output 118 and memory of the cradle 116. The PDA 102 is then loaded with the required respective first and second coordinates 111, 112 for identifying the front of a green and the middle of a green. When the golfer arrives at the first hole, the golfer will input a location on the first hole and the PDA 102 will calculate his or her location relative to the front and middle of the first green. The calculation is simply based upon the first and second coordinates 111, 112 relating to the first green as stored by operators of the present system as loaded onto the PDA 102 via the cradle 116 maintained at the golf course pro shop (or other location convenient to golfers). For example, when a golfer arrive at the first tee and designates the PDA 102 as such, the PDA display will indicate the following, for example:

1st Hole—Green Grass Golf Club

405 yds.—Front

420 yds—Middle

Once the golfer has hit his or her first shot and found the struck golf ball, the PDA will be refreshed and the display will indicate the following, for example:

1st Hole—Green Grass Golf Club

155 yds.—Front

170 yds.—Middle

Upon completing the first hole, the golfer will simply designate the second hole and repeat the process.

The alternate embodiment described above simplifies the underlying concept of the present invention by requiring the mapping of only 36 coordinates. In fact, it is contemplated that the 36 coordinates could be stored by an individual walking the course, uploaded to the central processor for data crunching, downloaded to the PDA of the individual taking the coordinates and stored within a cradle memory in a few hours (if not less).

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A system for providing golfers with golf related information, comprising:
a personal digital assistant including a GPS function, a memory, a processor and an input/output;
a cradle shaped and dimensioned for receiving the personal digital assistant and transferring information thereto, the cradle including a memory storing information relating to coordinates on a golf course and an input/output transmitting information to the personal digital assistant;
wherein the personal digital assistant includes means for calculating and displaying distance between a golfer's location and a designated coordinate on the golf course.

2. The system according to claim 1, wherein the coordinates stored within the memory of the cradle consist essential of the front and middle of each green on the golf course.

3. The system according to claim 1, wherein the coordinates are at most 36 coordinates found on the golf course.

4. A method for providing golfers with distance information, comprising the following steps:
measuring selected coordinates relating to positions on a golf course;
storing the coordinate information within a personal digital assistant cradle maintained at a golf course;
loading the coordinate information within a personal digital assistant including a GPS function, a memory, a processor, an input/output and means for calculating and displaying distance between a golfer's location and a designated coordinate on the golf course.

5. The method according to claim 4, wherein the step of measuring includes walking the golf course and taking location readings at preselected locations on the golf course.

6. The method according to claim 5, wherein the preselected locations are the front and middle of each green on the golf course.

7. The method according to claim 4, wherein the step of measuring includes taking at most 36 coordinate measurements on the golf course.

8. A cradle for use in transferring golf related information to a personal digital assistant including a GPS function, a memory, a processor including means for calculating and displaying distance between a golfer's location and a designated coordinate on a golf course, and an input/output, the cradle comprising;
a cradle body shaped and dimensioned for receiving the personal digital assistant and transferring information thereto; and
a memory storing information relating to coordinates on a golf course and an input/output transmitting information to the personal digital assistant.

9. The cradle according to claim 8, wherein the coordinates stored within the memory of the cradle consist essential of the front and middle of each green on the golf course.

10. The cradle according to claim 8, wherein the coordinates are at most 36 coordinates found on the golf course.
